(19) United States
(12) Patent Application Publication
(10) Pub. No.: US 2025/0128479 A1
(43) Pub. Date: Apr. 24, 2025

(54) PART MADE FROM RECYCLED COMPOSITE MATERIAL AND PRODUCTION METHOD THEREOF

(71) Applicant: FAIRMAT, PARIS (FR)

(72) Inventors: Benjamin SAADA, Paris (FR); Adrien CONTANT, PLOUGONVELIN (FR); Ugo DUBOIS, SALON DE PROVENCE (FR)

(21) Appl. No.: 18/723,215

(22) PCT Filed: Dec. 21, 2022
(86) PCT No.: PCT/EP2022/087372

§ 371 Date: Jun. 21, 2024

(30) Foreign Application Priority Data
Dec. 22, 2021 (FR) FR2114292

(51) Int. Cl. B29C 70/22; B29K 105/14; B29K 307/04

(52) U.S. Cl. CPC B29C 70/228; B29K 2105/145; B29K 2307/04; B29K 2995/0097

(57) ABSTRACT

The invention relates to a composite material part including
chips (1), each chip (1) having a substantially constant thickness defined between two parallel opposite faces (4) of the chip, each chip including carbon fibres (3) which are at least partly included in an adhesive cured during a first curing prior to the formation of said part, at least a majority of said fibres of the chip extending substantially parallel to said opposite faces (4) of the chip and
a matrix (2) in which each chip (1) is at least partly included, said matrix (2) being formed of a cured adhesive during a second curing,
such that a bonding interface is formed between the matrix (2) and each chip of the part.

The present invention relates to the field of recycling composite materials, in particular composite materials including carbon fibres.

The composite materials based on carbon fibres are used in many technical fields for their mechanical properties, in particular of strength and lightness. They are in particular commonly used in the aeronautical field, in the automobile industry, in boating, but also in the field of construction, energy, etc.

The composite materials based on carbon fibres, generally, include carbon fibres included in a matrix.

Several methods can be used to manufacture carbon fibres, the principle being a deposition of carbon at very high temperature, either from paper or viscose (“ex-cellulose” fibres), or from polyacrylonitrile (“ex-PAN” fibres), or from petroleum or coal residues (“ex-pitch” fibre).

The carbon fibres are included in the matrix in a given orientation, for example unidirectionally, or in the form of woven fibre web.

Concerning the matrix, generally, it consists of a polymer or it essentially includes a polymer. The matrix can also be called “adhesive”, or even “resin” (the matrix generally being a polymer). In a well-known manner, the matrix can be thermoplastic or thermosetting in nature. Glues which are similar in nature can be used in the same manner within the scope of the present invention.

Thus, unless otherwise provided, the terms “matrix”, “glue”, “adhesive” and “resin” are considered synonymous in this document.

Thermosetting polymers undergo a chemical reaction called crosslinking when shaping the composite material. This reaction generates chemical bonds and is irreversible. It is generally accepted that the most efficient thermosetting polymers for forming a composite material based on carbon fibres are polyepoxides (known as “epoxy”).

Thermoplastic polymers are polymers which, above a certain temperature, called “phase transition temperature”, lower than their thermal degradation temperature, become viscous and can thus be shaped. When the temperature drops below this phase transition temperature, the polymer cures and returns to its initial stiffness. This curing is reversible, by heating the polymer again.

The most common thermoplastic polymers are polyethylene (PE), polyethylene terephthalate (PET), or polycaprolactam (PA-6). For some applications, special thermoplastic polymers can be used, such as poly(phenylene ether ether ketone) (PEEK), poly(phenylene sulphide) (PPS), or polyetherimide (PEI).

As the applications of the composite materials based on carbon fibres are numerous and increasingly widespread, the question of recycling these materials arises. In addition to the fact that the amounts of materials that can be recycled are increasing, these composite materials are high-value materials (largely because they contain carbon fibres), the valorisation of which may prove economically relevant.

Recycling may concern elements made from composite material at the end of their life or having suffered damage, elements manufactured but which do not or no longer meet certain standards required for the use for which they are intended (in particular in the aeronautical or space field), or even, more rarely, elements which are not used on a certain date.

In order to recycle composite materials reinforced with carbon fibres, three main categories of methods have been developed: the so-called mechanical recycling, the so-called chemical recycling and the so-called thermal recycling.

The mechanical recycling consists, in principle, in splitting and grinding existing composite material parts to at least partially dissociate the fibres from the resin, so as to obtain fibres of varying length which can be reused as reinforcement in new resin. The slightly fibrous particles resulting from grinding, which are in powder form, can be mixed with a resin during the formation of a new composite material element.

The ground pieces of composite are used as filling elements or as reinforcement in moulded parts, but are not really intended to replace virgin carbon fibres as used in the conventional methods for manufacturing composite elements (based on non-recycled materials).

In this method, the powder obtained by grinding the composite materials to be recycled can be sieved to be sorted into several categories of particle sizes, without however this size having a significant influence on the mechanical properties of the element subsequently formed by including these particles.

Generally, it is estimated that the mechanical properties (flexural strength or bending stiffness) of a part obtained by a state-of-the-art mechanical recycling method are at least divided by four compared to a similar new part.

The composite materials based on recycled carbon fibres obtained by mechanical recycling methods therefore generally have a use limited to certain fields in which the mechanical properties, relative to the mass, do not need to be very high. They are thus mainly used in construction (buildings).

The chemical recycling consists in chemically degrading the cured resin of a composite material in order to recover carbon fibres present in this material. The recovered fibres are then generally aligned and/or spun in order to create a yarn from several thousand recovered fibres. The mechanical properties of the parts formed from composite materials including these recycled fibres are much lower than those of composite materials including new, non-recycled carbon fibres.

Several chemical degradation methods are known, in particular conventional solvolysis, solvolysis “under mild conditions”, or solvolysis under supercritical conditions.

In a conventional solvolysis method, the parts to be recycled are immersed in a solvent, at high temperature (more than 200° C.) and at high pressure (in the range of 180 bar), so that the resin is decomposed. These may, for example, be concentrated acids (in particular nitric acid or sulphuric acid).

In a solvolysis method under mild conditions, more moderate temperatures than in conventional solvolysis, below 200° C., are used. The method takes place at atmospheric pressure (ambient pressure), and milder solvents such as acetone or N, N-dimethylformamide are used, as well as possibly catalysts such as hydrogen peroxide or peroxyacetic acid. A pretreatment with acetic acid may also be used. This being said, solvolysis under mild conditions has a fairly low production efficiency.

In a solvolysis method under supercritical conditions, solvents are used under supercritical conditions to have better diffusivity and an increased solvation capacity. It is a complex and expensive method.

Finally, the thermal recycling consists in principle in thermally degrading the resin of a composite material to recover the carbon fibres therefrom. The heat can be provided by a pyrolysis method, which generally consists in burning the resin in an oven, by a fluidised bed method which uses the combined action of a solvent and a high temperature, and finally by micro-waves.

Although these methods are being optimised, the recovered fibres have significantly degraded mechanical properties compared to new fibres. The recovered fibres are generally short, they must be aligned and spun to be reused in applications requiring correct mechanical characteristics. Otherwise, they are used for filling, as are for example the powders obtained in the mechanical recycling methods mentioned above.

In summary, the different techniques known in the field of recycling composite materials based on carbon fibres consist in:
grinding the composite material to use the ground material as reinforcement (mechanical recycling);
or degrading the resin to regenerate carbon fibres (chemical or thermal recycling).

But these two solutions each have significant drawbacks: they offer materials having poor mechanical performance, and/or they are expensive and/or complex to implement. The recycling techniques in which the resin is degraded to recover the carbon fibres further have a significant environmental cost. Indeed, they release the degraded resin in liquid or gaseous form. These releases must be treated.

The present invention aims at proposing a composite material part obtained by a recycling method which overcomes all or part of the problems mentioned above. In particular, it aims at obtaining a composite material part with high mechanical properties, at a controlled economic and environmental cost.

Thus, the invention relates to a composite material part including chips which are at least partially included in a matrix. Each chip has a substantially constant thickness defined between two parallel opposite faces of the chip, each chip including carbon fibres which are at least partially included in an adhesive cured during a first curing prior to the formation of said part. At least a majority of the fibres of the chip extend substantially parallel to the opposite faces of the chip. The matrix in which each chip is at least in partially included is formed of an adhesive cured during a second curing. Thus, a bonding interface is formed between the matrix and each chip of the part.

The notion of substantially constant thickness is interpreted as follows. The thickness corresponds to the smallest dimension of the chip, which is small compared to the other dimensions thereof (for example compared to its length and its width for a chip in a rectangular shape). The thickness of the chip is substantially constant, because the chip has two opposite (main) faces which are substantially parallel at all points. Although the chip is flat in the absence of constraints, it can be curved once included in a part which is the subject of the present invention. This possible curvature is possible due to the small thickness of the chip, which gives it a certain flexibility. The thickness of the chip, measured perpendicular to the main faces of the chip, is constant at all points on the chip, or, at the very least, is perceived as constant by an observer. It is in this sense that it is indicated that the thickness is “substantially” constant, that is to say that it is naturally perceived as constant. Alternatively, it is considered that the thickness is substantially constant when the smallest thickness is not less than half of the largest thickness measured on a chip, and preferably when the difference between the largest thickness and the smallest thickness measured on a chip does not exceed 25%. Alternatively, it is considered that the thickness is substantially constant when the difference between the smallest thickness and the greatest thickness which are measured on the chip does not exceed 0.5 mm.

The bonding interface may essentially include mechanical adhesion bonds.

The term “mechanical adhesion bond” means a mechanical bond such as a mechanical anchoring (physical anchoring of the adhesive in the asperities of the solid surface of the chips), as well as possibly a bond by diffusion (diffusion of the adhesive in the chip) and/or a thermodynamic type bond, in particular of the “Van der Waals” type. The mechanical adhesion bonds are distinguished, by nature, from iono-covalent bonds.

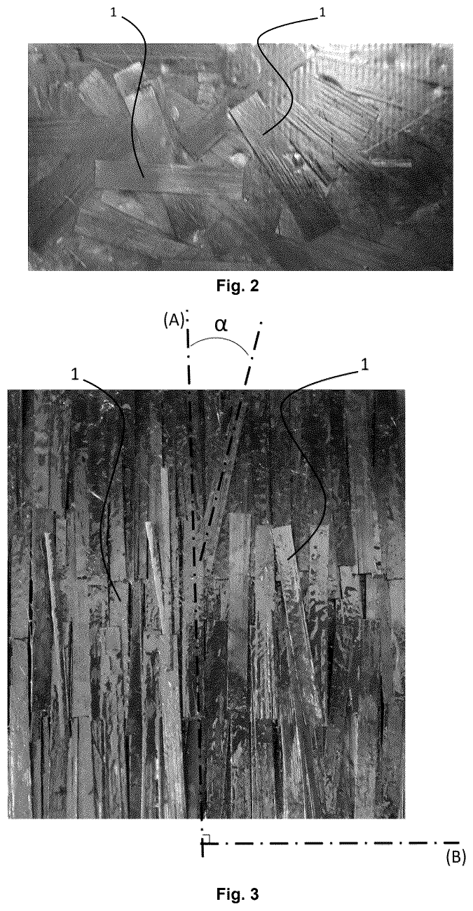

The expression “essentially mechanical adhesion bonds” expresses the fact that the first curing is deemed to be complete, but it cannot be excluded that there remain on the chips a few rare sites likely to form an iono-covalent bond with the matrix of the part. In other words, the chip adhesive is cured during the first curing, i.e. polymerised to a thermosetting or thermoplastic adhesive, such that it no longer contains (or almost no longer) a site allowing forming a chemical bond with the adhesive in which the chips are included for the second curing. Thus, the presence of an iono-covalent bond between the chip and the cured adhesive during a second curing is rare or even non-existent, so that the bonding interface between the chip and the adhesive is visible to the naked eye, as highlighted in FIGS. 2 and 3 described below.

Throughout this document, the term “substantially” conventionally refers the to perception of this characteristic according to the system used for the measurement or manufacture thereof. If a characteristic is observed with the naked eye, the term “substantially” therefore refers to an observer's perception of that characteristic. An expression containing the term “substantially” should be interpreted as a technical characteristic produced within the tolerance of the manufacturing method thereof. In the particular, “substantially parallel” character between two elements can be understood to within 10° of angle. If the considered fibre is included in a fabric (typically taffeta, twill or satin), the direction of extension of the fibre is considered by neglecting the undulations of the fibre related to weaving.

The term “chips which are at least partially included in a matrix” means the fact that each chip is embedded in the matrix, with the possible exception of certain chips that may emerge on the surface of the part. Similarly, the term “carbon fibres which are at least partially included in an adhesive cured during a first curing” means the fact that the carbon fibres are embedded in the adhesive of a chip, with the possible exception of certain fibres which may emerge on the surface area of the chip.

The curing process (or crosslinking, these terms being used synonymously unless otherwise stated) transforms a resin through a crosslinking process. Energy and/or catalysts are added to cause the molecular chains to react at chemically active sites binding into a rigid 3D structure. The cross-linking process forms a molecule with a higher molecular weight, resulting in a material with a higher melting point. During the reaction, the molecular weight increases until the melting point is higher than the surrounding ambient temperature, and the material transforms into a solid material.

The adhesives suitable for composite materials can be selected from the group consisting of thermosetting resins such as epoxy resins, cyanate ester and phenolic resins. The suitable epoxy resins comprise bisphenol A diglycidyl ethers, bisphenol F diglycidyl ethers, novolac epoxy resins and N-glycidyl ethers, glycidyl esters, aliphatic and cycloaliphatic glycidyl ethers, aminophenol glycidyl ethers, glycidyl ethers of any substituted phenols and mixtures thereof.

Modified blends of the aforementioned thermosetting polymers are also included.

By “modified blend”, reference is made to a polymer which is modified, typically, by the addition of rubber or thermoplastic.

Any suitable catalyst (or “curing agent”) can be used. The catalyst will be chosen to match the used resin.

The catalyst can be accelerated.

For example, when a dicyandiamide catalyst is used, a substituted urea can be used as an accelerator.

The agent of curing with an epoxy resin can also be selected from Dapsone (DDS), Diamino diphenyl methane (DDM), BF3-amine complex, substituted imidazoles, accelerated anhydrides, metaphenylene diamine, diaminodiphenyl ether, aromatic polyetheramines, aliphatic amine adducts, aliphatic amine salts, aromatic amine adducts and aromatic amine salts.

Suitable accelerators include Diuron, Monuron, Fenuron, Chlortoluron, toluenediisocyanate bis-urea and other substituted homologs.

The adhesives suitable for the composite materials can also be selected from the group consisting of thermoplastic resins. Among thermoplastics, it is possible to distinguish high-performance plastics, engineering plastics and standard plastics. Most thermoplastics used in the composite materials are high-performance plastics or engineering plastics. These plastics are distinguished in particular from standard plastics by greater wear resistance and chemical resistance.

The thermoplastics, depending on their nature, can be hard in amorphous form or in crystalline form.

Among the amorphous thermoplastics which are commonly used in the composite materials, there are polyetherimides (PEI), polyethersulphone (PES), and polysulphones (PSU).

Among the crystalline thermoplastics which are commonly used in the composite materials, there are polyamides (PA), poly(ethylene terephthalate), polyphthalamide (PPA), poly(phenylene sulphide) (PPS), and polyetheretherketone (PEEK).

Each chip has been formed so that it has an orientation of the majority of the fibres it contains, parallel to the faces of the chip. Thus the fibres can have a significant length and a controlled orientation in the chip. Ultimately, the length and orientation of the fibres in the chips, and the arrangement of the chips in the part give it high mechanical properties.

The chips are in particular obtained by cutting from composite material elements based on carbon fibres to be recycled, as explained in more detail below. The formation of a part in accordance with the invention therefore allows the recycling of such elements, according to a low-polluting mechanical method, while offering good mechanical performance to the formed part.

The faces of each chip can have a surface area called surface area of the chip of at least 1 cm².

These values given by way of example are to be understood as minimums. According to the considered parts, the chips can have a much greater surface area, for example in the range of 3 cm², 5 cm², 10 cm² or 20 cm², 100 cm².

The chips formed and used within the scope of the present invention thus have a significant surface area, allowing the inclusion of carbon fibres of great length since the latter extend substantially parallel to the opposite faces of the chip.

The bonding interface between each chip and the matrix may not have an inflection point, over the entire surface area of the chip.

In particular, the interface can be substantially planar over a majority of the surface area of the chip.

This is due to the relative rigidity of each chip, which includes carbon fibres in a cured adhesive, before inclusion in a matrix to form the composite material part.

Each chip advantageously has a small thickness (e) compared to its other dimensions. A chip thus being an essentially two-dimensional piece, of small thickness, the other dimensions thereof typically correspond to the largest dimension (d) that can be measured on the surface area of the chip and to the dimension measured perpendicularly, also on the surface area of the chip.

Advantageously, the ratio (e)/(d) is comprised between 0.05 and 0.0005, preferably between 0.01 and 0.001 and even more preferably between 0.005 and 0.001.

In this application, unless otherwise indicated, the ranges are understood to be inclusive.

In the composite material part, the carbon fibres advantageously extend mainly in parallel planes.

For example, the chips may have a unidirectional arrangement of the carbon fibres. For example, the chips can be oriented such that the carbon fibres of the part are substantially oriented in the same direction. Alternatively, the chips can be oriented such that the carbon fibres of the part are substantially oriented in only two distinct directions, for example a first direction and a second direction forming an angle of 90° therebetween.

The chips are advantageously disposed in the part in a repeating pattern.

A pattern corresponds to a particular relative arrangement of several chips. A pattern corresponds in particular to a non-random arrangement, which is generally repeatable in the part which is formed.

According to one embodiment, the carbon fibres present in each chip are arranged in webs each having a carbon fibre weaving.

Thus, a controlled orientation of the chips and therefore of the fibres in the part allows obtaining the desired mechanical properties.

In the composite material part, the chips can all have substantially the same shape and same dimensions. For example, each chip is substantially rectangular in shape (that is to say the faces of each chip are substantially rectangular).

The two-dimensional shape of the chips is thus a parameter that can be optimised to improve the mechanical properties of the part, and/or adapt to the shape of the elements to be recycled.

The thickness of the chips can for example be comprised between 200 μm and 1 mm.

The invention also relates to a composite material part including fibrous areas, formed by the chips and representing between 20% and 85% by volume of the part and non-fibrous areas, consisting of the adhesive which is added and cured during the second curing, forming the remainder of the part.

The invention also relates to a composite material part including:
a plurality of areas including carbon fibres and a first adhesive, the carbon fibres having a non-random orientation within the same area, said areas including carbon fibres having a substantially constant thickness defined between two parallel opposite faces, and all carbon fibres of said areas including carbon fibres being oriented along substantially parallel planes, and
at least one area devoid of carbon fibres, including a second adhesive,
the plurality of areas including carbon fibres and a first adhesive being at least partly included in the at least one area devoid of carbon fibres including a second adhesive.

The term “all carbon fibres in said areas being oriented along substantially parallel planes”, means that the carbon fibres present in said areas are oriented along substantially parallel planes, and this, from one area to another.

The term “the plurality of areas including carbon fibres and a first adhesive being at least partially included in the at least one area devoid of carbon fibre including a second adhesive”, means that the second adhesive of the at least one area devoid of carbon fibre encompasses at least 75%, preferably at least 80%, even more preferably at least 85% such as for example 90%, of the surface area of the plurality of areas comprising carbon fibres and the first adhesive.

As described in more detail below with reference to FIG. 5, a sectional view of a composite material part according to the invention allows visualising the plurality of areas including carbon fibres (the striped light grey parts shown in FIG. 5, the streaks being the carbon fibres) and at least one area devoid of carbon fibres (dark grey part).

The areas including carbon fibres can also be distributed throughout the composite material part in a pattern.

Advantageously, the areas including carbon fibres represent between 20% and 85% by volume of the part.

The areas including carbon fibres, also called fibrous areas, are in fact the chips included in the composite material part.

According to a first embodiment, the first adhesive is identical to the second adhesive, the first adhesive having been cured before the second adhesive.

According to a second embodiment, the first and second adhesives are different.

In such a part, the carbon fibres can be oriented in a substantially parallel, orthogonal and/or 45° manner within the same area.

The composite material part can, for example, be a flat or curved panel.

The invention further relates to a method for manufacturing a composite material part, said method including the steps of:
providing a composite material including carbon fibres in an adhesive cured during a first curing;
cutting the composite material into chips, each chip having a substantially constant thickness defined between two parallel opposite faces of the chip, each chip including carbon fibres which are at least partially included in an adhesive cured during a first curing, at least a majority of said fibres of the chip extending substantially parallel to said opposite faces of the chip;
coating the chips with an adhesive;
disposing the chips so as to form an entanglement of chips (that is to say a superimposition forming a nesting and/or an intermingling of the chips);
curing the liquid adhesive, called second curing.

The invention finally relates to a composite material part likely to be obtained by such a manufacturing method.

Other features and advantages of the invention will appear in the description below.

In the appended drawings, given by way of non-limiting examples:

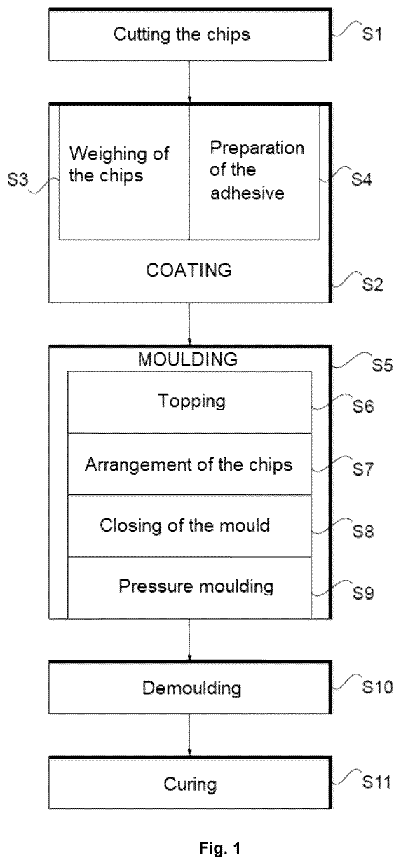

FIG. 1 schematically represents, according to a block diagram, a method in accordance with one embodiment of the invention;

FIG. 2 represents, in a photograph, a so-called random chip arrangement that can be implemented within the scope of the present invention;

FIG. 3 represents, in a photograph, a so-called unidirectional chip arrangement which can be implemented within the scope of the present invention;

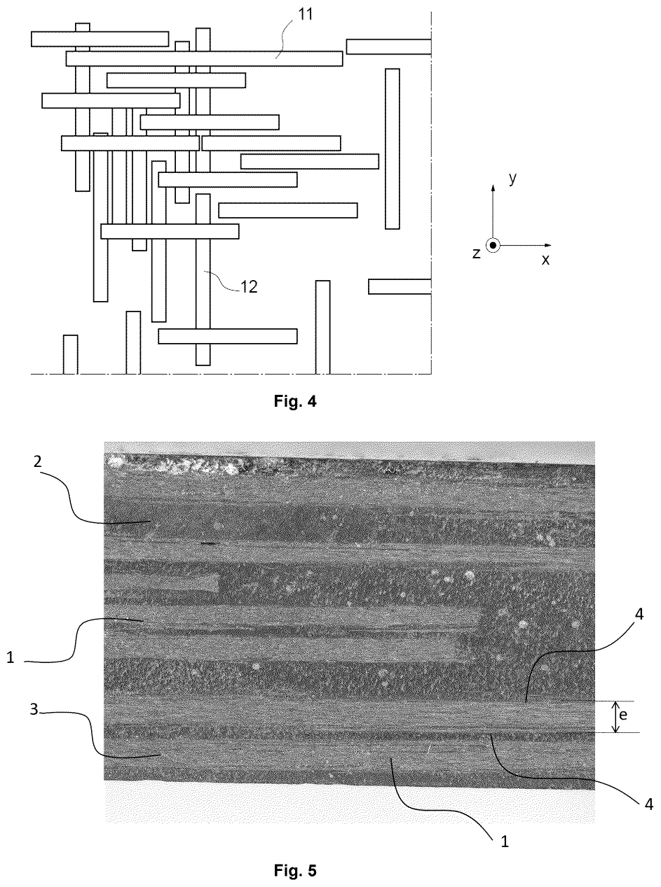

FIG. 4 schematically represents a so-called bidirectional chip arrangement that can be implemented within the scope of the present invention;

FIG. 5 represents, in the form of a photograph, a section of a composite material part according to one embodiment of the invention, at ×50 magnification;

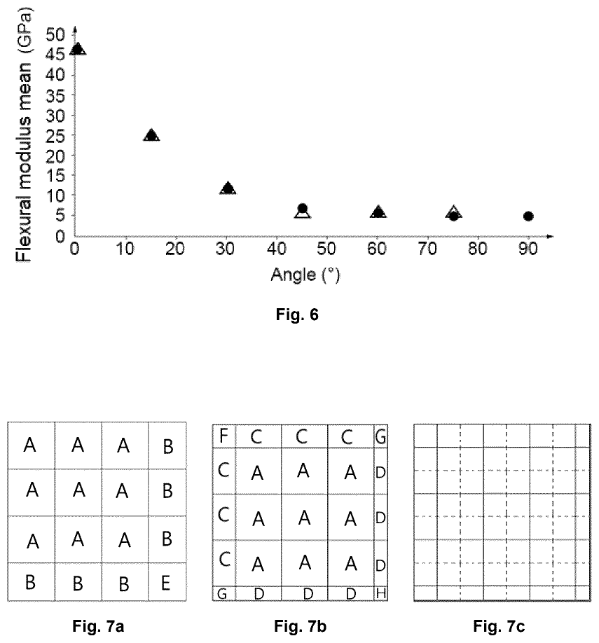

FIG. 6 represents, in the form of a graph, the flexural modulus of a panel in accordance with an embodiment of the invention whose chips are organised unidirectionally, and that of a panel containing new carbon fibres which are oriented unidirectionally;

FIGS. 7a, 7b and 7c illustrate an aspect of a panel produced according to one embodiment of the invention in which the arrangement of the chips is carried out according to a non-random pattern;

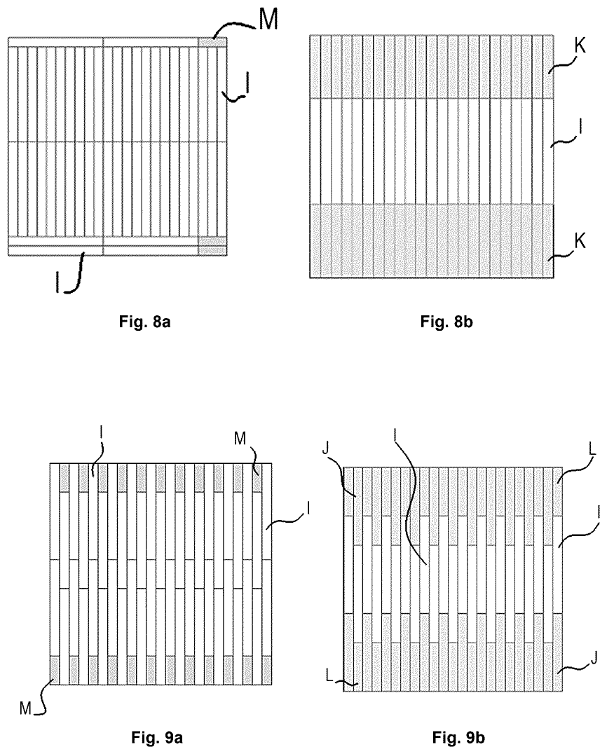

FIGS. 8a and 8b illustrate an aspect of another panel produced according to one embodiment of the invention in which the arrangement of the chips is carried out according to a non-random pattern;

FIGS. 9a and 9b illustrate an aspect of yet another panel produced according to one embodiment of the invention in which the arrangement of the chips is carried out according to a non-random pattern.

FIG. 1 schematically represents, according to a block diagram, a method in accordance with one embodiment of the invention, allowing obtaining composite material parts in accordance with one embodiment of the invention.

The method implements the steps described below.

### Cutting the Chips (Step S1).

The implementation of the present invention requires the formation of chips from composite material elements based on carbon fibres which are to be recycled.

To do this, the chips are obtained by mechanically cutting said elements.

The chip cutting can be carried out using a cutting machine such as a blade device. The blade device may be a planer type system. A planer type system corresponds to a cutting machine including a blade allowing thin slices of regular thickness to be separated from the surface of an element over which it has passed.

When an element is cut to form chips, the blade of the blade device is positioned, in a conventional manner, such that its edge extends in a plane parallel to the cutting direction.

The material to be cut is positioned in the cutting machine according to the organisation of the carbon fibres it contains.

If the fibres in the material to be cut are unidirectional, that is to say included in a matrix substantially parallel, in only one direction, then the fibres are positioned parallel to the direction of advancement of the blade device.

If the fibres are included in the form of woven webs, the part will preferably be placed such that the weft or warp threads are substantially parallel to the direction of advancement of the blade device.

The fibres can also be disposed in a succession of layers, each layer including unidirectional fibres, but the layers having different fibre orientations. This is for example the case for materials called “four-directional” materials, the layers of which can have the following successive relative orientations: 0° (reference layer), 90°, 45°, −45°.

The blade device can advantageously be adjusted such that the blade thereof attacks the element between two layers of fibres, whether they are two layers of unidirectional fibres or two woven webs.

The cutting plane will advantageously be maintained between the layers of fibres in order to maintain their integrity as much as possible.

Thin slices of composite material are thus obtained. These slices can in particular have a thickness comprised between 200 μm and 1 mm, preferably between 200 μm and 500 μm.

The elements to be cut are brought to the desired length for the chips before being cut into slices by the cutting machine, such that the chips having the desired length are obtained directly at the outlet of the cutting machine.

Alternatively, the slices are then recut to obtain chips. Typically, they are cut transversely by any suitable cutting means, for example by sawing, in order to form fine rectangular chips of regular length. Other shapes of chips can of course be cut from the obtained slices.

For example, for the production of planar panels, chips of 10 cm to 20 cm in length were obtained and allowed obtaining very good results in terms of mechanical performance as exemplified below. Greater lengths can also be implemented, such as in the range of 50 cm or even 1 m.

Obviously, the cutting method described above can be adapted according to the considered application and the amounts to be produced.

When the material to be recycled is a pre-coated, but uncured, carbon fibre fabric, this material is first cured (polymerised for a material coated with a thermosetting resin) then cut to the desired shape of the chip. Such a fabric generally having a thickness comprised between 200 μm and 500 μm, the chip thus obtained has a thickness entirely adapted to be implemented according to the present invention for the formation of a part, in particular moulded, made of composite material.

Once the chips are formed, they therefore take the form of fine elements including carbon fibres which are, at least partially, included in a cured resin. The chips are therefore in the form of substantially two-dimensional parts (in that their thickness is very small compared to the other dimensions thereof). The surface of the is chips advantageously of at least 1 cm², and preferably greater than 3 cm², in the range of 10 cm², or even greater, for example up to approximately 100 cm².

The curing of the matrix of the chips being prior to the formation of the final part by moulding, reference is made to first curing (in order to distinguish it from the curing of the matrix of the part, which aims at binding the chips, and which will be carried out during of the moulding of the part).

The carbon fibres are oriented in the cured resin of the chips. Preferably, they are substantially parallel, orthogonal to each other, and/or oriented at 45° from each other.

The fibres of the chips having a substantially constant thickness, they include two opposite faces (between which the thickness is defined). The cutting of the chips is carried out so as to keep the carbon fibres intact as much as possible. To do this, the chips are cut such that the fibres (the majority, or even almost all or all of them) extend parallel to the opposite faces of the chips. The fibres thus extend in planes which are parallel to the general plane of extension of the chip, and can have a great length despite the small thickness of the chips.

The term “majority”, means more than 50% in number;

The term “almost all”, means more than 90% in number.

### Coating (Step S2).

The chips are then mixed with a liquid adhesive in order to coat them, with a view to moulding them.

This step can be carried out before placing the chips in the mould intended to form the desired part, or during or even after placement in the mould. We describe below the obtaining of parts in accordance with one embodiment of the invention on a pilot or prototype scale. In this example, the chips are mixed with an adhesive before being placed in a mould.

On the prototype scale, the mixture can be carried out manually in a suitable container, for example made of aluminium.

The chips are first weighed into the container (step S3), then the adhesive (for example a resin/curing agent system, see below) is prepared (step S4) and added. The coating is complete when each chip is evenly covered with adhesive.

Adding the adhesive and mixing the chips and adhesive can be done automatically. An automatic mixer can be used to stir the chips and the adhesive.

The amount of adhesive to be added to the chips is determined according to the characteristics of the part (for example the panel) that is intended to be produced.

The amount of adhesive to be added depends, for example, on the desired volume or mass percentage of chips in the final material, to obtain the desired mechanical properties, and on the used adhesive, in particular its density.

The masses applied are also determined the thicknesses of panels that are intended to be obtained.

For many applications in which significant mechanical performance is sought, it is appropriate to maximise the proportion of chips in the material. The Applicant has produced parts containing up to 80% mass percentage of chips, and estimates that parts containing up to 85% mass percentage of chips, or even slightly more, can be produced successfully.

Various adhesives can be used successfully. In general, all adhesives known to be used as a matrix in composite materials including carbon fibres can be used, with the possible exception of adhesives which would be incompatible with the cured adhesive present in the chips.

The term “incompatible” means that the used adhesive would cause an unwanted chemical reaction with the cured adhesive present in the chips or would be poorly suited to forming mechanical bonds with the chips.

By way of example, two two-component epoxy system type adhesives are mentioned below.

The two-component epoxy system include an epoxy resin and a curing agent.

When the resin and curing agent are contacted, the polymerisation begins. The polymerisation time varies depending on the nature of the system used.

The first two-component epoxy system mentioned by way of example is the system marketed by the company SIKA under the name ADEKIT H9011 (ADEKIT is a registered trademark).

This system is a common system and which can be used, according to the recommendations of its manufacturer, for applications of gluing of many metals, ceramics, glass, rubber, rigid plastics, or even the bonding of common materials. It is suitable for most industrial craft applications.

The resin is light amber in colour, with a density at 25° C. of 1.16, and a viscosity at 25° C. of 25 to 50 Pa·s. The curing agent is amber in colour, with a density at 25° C. of 0.96 and a viscosity at 25° C. of 20 to 40 Pa·s. The mixture of the two is light amber in colour, with a density at 23° C. of 1.07 after polymerisation, and a viscosity at 25° C. of 25 to 50 Pa·s. The mixture proportions by mass of the resin/curing agent mixture are 100/80, the proportions by volume at 25° C. are 100/100. The duration for which the mixture can be used after contacting the two components (generally referred to by the expression “pot-life”, and which is given for a given mass and temperature) on 110 g at 25° C. is 100 minutes.

The transparency of the adhesive once cured allows seeing the chips in the final part.

The second two-component epoxy system mentioned by way of example is a system marketed by the company SICOMIN under the name “SR 1700 EPOXY RESIN+SD 2803 STANDARD CURING AGENT”.

This system is a common system and can be used, according to the recommendations of its manufacturer, for lamination applications in various fields such as boating, bodywork and model making.

The mixture has a viscosity at 20° C. of 0.6 to 0.7 Pa·s. The mass mixing proportions of the resin/curing agent mixture are 100/39, the proportions by volume are 100/45. The duration for which the mixture can be used after contacting the two components (generally referred to by the expression “pot-life”, and which is given for a given mass and temperature) on 500 g at 20° C. is 120 minutes.

As indicated above, numerous adhesives can be used for forming parts in accordance with various embodiments of the invention. In particular, systems intended for composite production applications (infusion, injection, lamination resins), but also provided systems for structural applications as adhesives.

The systems can in particular have a density comprised between 1.03 to 1.38 at 25° C. Their dynamic viscosity can in particular be between 0.4 and 80 Pa·s. They can in particular have a modulus of elasticity (once cured) comprised between 2 GPa and 4 GPa.

The polymerisation of these adhesives can be done at ambient temperature or at a higher temperature, in the range of 70° C.

The polymerisation times being substantially different depending on the thermosetting adhesive system, the choice of the system can also depend on this time, according to the mechanical properties and the desired cycle times.

Alternatively, the adhesive may be thermoplastic.

Finally, and independently of the colour additives that can be added to the adhesive (as explained below), each adhesive has a particular colour and a particular transparency (or opacity). This can be leveraged to obtain the desired appearance for the final part.

Additives can also be added to the adhesive, for example to the glue/curing agent mixture, before coating the chips.

The additive(s) may comprise dyes, pigments, pigment pastes (pigments already mixed with a resin).

A significant colouring of a transparent resin could be obtained by mixing only 0.94% of paste relative to the mass of the resin/curing agent mixture. This proportion was enough to give a very opaque colour to the mixture. The colour is visible on the parts, for example the panels, which are obtained after moulding.

The chips on the surface of the part remained visible, giving a rewarding and technical appearance to the part.

With the different colour additives (pigments, pigment paste . . . ) on the market that have been tested, a good colouring is obtained with at most 5% by mass of pigments and/or at most 5% by mass of dyes.

The additive(s) can also include fillers. Fillers designate all particulate elements that can be added to the adhesive to change its properties, and/or to lower its cost at equal volume. The considered fillers include in particular mineral or organic particles likely to improve certain properties of the final part, in particular its resistance to scratching or abrasion.

These fillers are most often of a mineral nature (aluminium, calcium fillers . . . ) in the form of particles whose size is in the range of magnitude of a nanometre or micrometre.

The adhesive may also comprise glass microbeads.

The used filler may also include carbon dust, for example from operations of preparation and cutting of the elements to be recycled. In this case, it is therefore an organic filler.

Moulding (step S5).

The mixture of chips and adhesive is then moulded.

As explained above, adhesive is optionally used to make a topping (step S6) of the mould. Topping allows creating a layer of resin on the surface and gives the produced part a beautiful surface finish, for example smooth or perfectly matching the surface finish provided by the mould.

As an alternative to topping, overmoulding can be carried out. To do this, at the end of polymerisation (see below), resin is injected into the mould to cover the moulded part, and obtain an effect similar to that of the topping. The high injection pressure during overmoulding can allow adding functional elements to the surface of the moulded part (grooves, notches, rails, etc.) or creating the desired surface appearance.

As an alternative e or in addition to topping or overmoulding, a gel coat (which can be translated as gel coat) can be applied to the mould. And as an alternative to the gel coat, a top coat (which can be translated as finishing coat) can be applied to the part once it has been moulded.

It is considered below that a planar panel is produced.

The used mould has a concave portion, called a female imprint, and a part forming a corresponding male imprint.

The coating is made on the surface of the female imprint and on the surface of the male imprint. For a planar panel, the surface area of the female imprint is equal to that of the male imprint, and the following rule can be used.

For each side, 10% of the amount of adhesive to be used plus half the amount of excess adhesive (that is to say the amount of adhesive which is deliberately provided in excess and which is will escape during moulding) are applied.

For the topping made on the side of the male imprint, the adhesive can be deposited on the surface of the male imprint or on the chips once they have been placed in the female imprint, as described below.

For example, if the amount of glue to be used is 68 g and the excess glue is 5 g, the amount of glue for the topping will be 9.3 g for each side, or 18.6 g in total.

In order to create the topping, the glue can be applied using a flexible applicator, or projected on the walls to be covered. Depending on the scale of production, this step can be carried out by an operator or automatically.

Before topping and/or placing the chips, a mould release agent can be applied on the inner surface of the mould in order to facilitate the extraction of the part once it has been formed.

When the chips have been mixed with the adhesive, they should be disposed in the female imprint of the mould, then finalised with the press moulding.

According to the considered scale of production, the placement of the chips can be carried out manually, using templates or visual cues (for example guides formed by a laser), or automatically.

The chips covered with adhesive are placed in the female imprint of the mould, on an extraction plate. The extraction plate allows the panel to be extracted from the mould after the pressing action. It can also be used to adapt the thickness of the panel that is formed (several thicknesses can be made in the same mould by varying the thickness of the extraction plate). If an extraction plate is used, it then forms the inner surface of the mould and it will therefore be the extraction plate which will be topped with adhesive, if necessary, and previously with mould release agent, also if necessary.

The step of arrangement of the chips (step S7) in the mould can be important for the mechanical properties of the panel (or more generally of the part) which is formed.

Starting from the hypothesis that the chips have unidirectional carbon fibres, the chips can be arranged in the mould according to three main types of distribution.

A first arrangement is called random arrangement. The term “random” means that the chips are arranged in various orientations, and are superimposed on each other in an irregular manner. An example of a so-called random arrangement is represented in FIG. 2. FIG. 2 more specifically represents surface of a planar panel according to an embodiment of the invention in which the chips have a so-called random arrangement. The chips used here are rectangular. A panel with a random chip arrangement 1 is generally substantially isotropic in the plane in which it extends, as far as its mechanical properties are concerned.

When a random arrangement of the chips 1 in the mould is carried out, the Applicant has nevertheless noted that the volumes left free by the superimposition of the chips must be minimised, in particular for panels of small thickness (typically less than or equal to 2 mm).

A second arrangement is called unidirectional arrangement. An example of a so-called unidirectional arrangement is represented in FIG. 3. According to this arrangement, the chips are all arranged in the same direction (A), that is to say that the carbon fibres contained in the different chips are all substantially oriented in the same direction. An angle tolerance, in the range of plus or minus 10°, is acceptable. This tolerance is measured according to the angle α formed between the theoretical direction (A) of the chips 10 and the general extension direction of each chip (typically the direction along the length of the chip, for a rectangular chip). It is moreover admissible that a maximum of 10% of the chips do not respect the desired orientation and angle tolerance. Nevertheless, a lower tolerance of angle and/or proportion of incorrectly oriented chips can be reached, which contributes to obtaining the desired mechanical properties. The chips 1 are therefore oriented in the same manner, but without being strictly organised relative to each other according to a structure which could induce weaknesses in the panel. An irregular arrangement of the chips, in the longitudinal direction and in the transverse direction, while guaranteeing their longitudinal alignment, is thus preferred. This arrangement allows obtaining an anisotropic panel with regard to its mechanical properties. These properties, in particular bending strength and breaking strength, are very significant in the direction (A) of alignment of the chips and fibres, to the detriment of the direction (B) orthogonal to the fibres.

A third arrangement is called multidirectional arrangement, such as for example, bidirectional arrangement. An example of a so-called bidirectional arrangement is represented in FIG. 4. It consists in making several plies (each including one or more layers of chips) with different chip orientations between adjacent plies. For example, with rectangular chips, it is possible to alternate the plies, with an arrangement of the chips of one ply at 90° to the chips of adjacent plies. A bidirectional arrangement can therefore be defined as a stack of unidirectional layers as previously described. Two plies are partially represented in FIG. 4 (that is to say that only certain chips of each ply are represented to illustrate the superimposition of the chips), namely an upper ply in which the chips are oriented in a first direction (x), and a lower fold in which the chips are oriented in a direction (y) orthogonal to the direction (x). The chips of the planar panel taken here by way of example are positioned parallel to the (x, y) plane.

According to the principle described above, any multidirectional arrangement can be considered.

The arrangements presented above relate to a thin planar panel. For the formation of a part having a significant thickness (for example a cube) or having a complex three-dimensional shape, it is also possible to position the chips for moulding orthogonal to the planes of extension of the chips forming a random, unidirectional, or bidirectional configuration as described above. These chips which extend through the thickness of the part increase the mechanical properties of the part in their direction of extension. Considering an orthogonal coordinate system (x, y, z), as shown in FIG. 4, the majority of the chips being oriented in planes parallel to the plane (x, y), the chips positioned orthogonally, in the z direction (for example parallel to the (x, z) plane or the (y, z) plane, thus mechanically reinforce the part in the z direction.

Generally, the arrangement of the chips, as long as it is not purely random, can be such that the chips form a particular pattern which is repeated to form the panel (or more generally a part).

A pattern corresponds to a particular arrangement of several chips therebetween in the three dimensions. Thus, with the exception of a purely random arrangement, the other considered arrangements (unidirectional, bidirectional, multidirectional, with where appropriate a three-dimensional arrangement of the chips, etc.) can be considered as the repetition of a pattern of chips.

Examples of patterns, illustrating the advantages which can be obtained thanks to a non-random arrangement of the chips, are given below (Example III and Example IV).

The arrangement, geometry, size of the used chips and the thickness of the plies can be adapted according to the intended application.

To a certain extent, the longer the chips, the better the mechanical properties. However, in practice, the length of the chips that can be formed and used depends on the elements that are recycled, and the new formed parts and in particular on their geometric complexity (it is quite obvious that it is easier to integrate chips of large length in a large planar panel than in a curved part, with complex geometry, and/or having numerous geometric details). As a general rule, it is advantageous to implement chips whose largest dimension, such as length, is comprised between 3 and 20 cm.

Preferably, the plies forming the outer surfaces of the part (for example of the two opposite faces of a panel) have the chips 11 thereof which are oriented longitudinally, that is to say in the main extension direction of the part, or if this direction cannot be determined, in an arbitrarily fixed direction, and the inner ply, or one in every two inner plies, has the chips 12 thereof which are oriented transversely (that is to say perpendicular to the chips which are oriented longitudinally). By varying the thicknesses of each ply, it is also possible to vary the performance of the panel in these two directions.

In all the arrangements presented above, each ply can have one or more layers of chips.

Once the chips have been disposed in the female imprint of the mould, the mould is closed by positioning the male imprint (mould closing step S8).

The mould is installed in a press, which is activated in order to put the contents of the mould under pressure (press-moulding step S9). Panel prototypes were produced by applying a force of 20 ton-force (approximately 1600 daN). A substantially less pressure could nevertheless be sufficient. When a thermosetting resin is used, the polymerisation can take place at ambient temperature. Advantageously, the mould can be heated to accelerate the polymerisation. In order to obtain an efficient and homogeneous heating (a temperature in the range of 70° C. may be desired), two heating plates can be used, on either side of the mould. In order to regulate the heating, and take into account the exothermic nature of the polymerisation of the adhesive, a closed loop control, for example of the PID type (proportional, integral, derivative) can be used.

The part is demoulded when the adhesive has cured sufficiently to make the part which can be manipulated without deformation (demoulding step S10). However, the polymerisation is not necessarily completely completed upon demoulding. This allows releasing the press for other mouldings.

In order to finalise the curing of the parts (step S11), they can be placed in an oven, typically at 70° C.

For the ADEKIT H9011 system, the polymerisation time is 16 hours at 70° C. For comparison, the complete polymerisation of this adhesive takes around a week at ambient temperature.

The method described above thus allows obtaining moulded parts made of composite material formed from composite material elements based on carbon fibres which are desired to recycle.

The method described above implements a moulding of the part. Alternatively, other shaping techniques can be used. For example, a pultrusion method or a calendaring method may be used.

In a pultrusion method allowing obtaining parts in accordance with the present invention, the chips are coated and oriented in a nozzle and exit said nozzle with the desired arrangement in a resin undergoing a (second) curing. The pultrusion can be used, in particular, to obtain very long parts (beams, panels, etc.).

In a calendaring method allowing obtaining parts in accordance with the present invention, a mass of adhesive in the process of polymerisation and including the correctly arranged chips passes through the roller gap in order to form a thin part, for example a thin panel.

Unlike known recycling methods, which generally aim at extracting the carbon fibre with a view to its reuse, it is proposed in the invention to form chips in which the fibres remain, at least partially, included in the cured matrix of the recycled element.

Many part geometries can be obtained.

FIG. 5 represents, in the form of a photograph, a section of a composite material part according to one embodiment of the invention, at ×50 magnification. In this case, FIG. 5 represents the section of a planar panel including chips 1 positioned parallel to each other and included in a matrix 2. The chips 1 of FIG. 5 are rectangular chips, which are arranged unidirectionally in a longitudinal direction. The section which is made is a longitudinal section of the panel, perpendicular to the plane in which said panel extends.

In this sectional photograph, the chips 1 appear as light grey streaked portions, the streaks corresponding to carbon fibres 3, the areas internal to the chips located between the carbon fibres 3 corresponding to the adhesive cured during a first curing.

The matrix 2, which is formed from an adhesive cured during a second curing, and in which the chips 1 are included, corresponds to the areas devoid of carbon fibres which appear in dark grey in FIG. 5.

The chips 1 remain distinct from the matrix 2, such that a bonding interface between each chip 1 and the matrix 2 is perceptible. FIG. 5 thus allows visualising that each chip is an essentially two-dimensional element of small thickness e. The thickness e of the chip is measured between the two parallel faces 4 of the chip 1 (the thickness being, conventionally, the smallest distance between the faces 4, that is to say measured perpendicular to these faces 4).

### EXAMPLE I: CHARACTERIZATION OF THE PANELS OBTAINED ACCORDING TO THE INVENTION

The Applicant has carried out characterization tests, in terms of mechanical characteristics, of the materials obtained according to the present invention, described in the following examples.

The tests, the results of which are described below, were carried out on prototype plates measuring 23 cm by 23 cm and having a thickness comprised between 3.5 mm and 3.6 mm.

The chips used in the tests presented here are from composite material elements including carbon fibres in a unidirectional arrangement included in an epoxy resin type adhesive. The elements used are from the aeronautical industry. The composite material had characteristics identical or similar to the “UD carbon plate” material, the characteristics of which are indicated in Table 1 below.

The chips used are rectangular, and have a length 1 of 100 mm, a width b of 9 mm and a thickness comprised between 0.3 mm and 0.5 mm.

The plates are produced according to a method as previously described with reference to FIG. 1.

The mould is coated with a mould release agent and is topped under the conditions described above.

The adhesive used is the ADEKIT H9011 system used according to the recommendations of its manufacturer, recalled above.

The chips are manually positioned in the mould.

The ratio of chips to adhesive is, unless otherwise stated, 65/35 by mass in the finished plate.

The moulding is carried out under a press, by applying a force of 20 ton-force, and by controlling the temperature to approximately 70° C.

After unmoulding, the plates are kept for a week at ambient temperature (20° C.) before being used for measurements.

Tests allowed obtaining the results presented in the following table.

The characteristics of plates in accordance with embodiments are presented therein, compared to reference materials.

TABLE 1

| | | Longitudinal | | Transverse | | | |
|---|---|---|---|---|---|---|---|
| | | direction | | direction | | | |
| | | performance (0°) | | performance (90°) | | Performance 45° | |
| | | Flexural | Tensile | Flexural | Tensile | Flexural | Tensile |
| | Density | modulus | strength | modulus | strength | modulus | strength |
| Material | (g/cm\hat{ }3) | (in GPa) | (in MPa) | (in GPa) | (in MPa) | (in GPa) | (in MPa) |
| Aluminium | 2.7 | 70 | 300 | 70 | 300 | 70 | 300 |
| (5754 H22) | | | | | | | |
| Wood | 0.8 | 14 | 110 | 10 | 100 | 12 | 100 |
| (Beech) | | | | | | | |
| UD carbon | 1.45 | 150 | 1500 | 5 | 40 | 10 | 100 |
| plate | | | | | | | |
| Bidirectional | 1.45 | 65 | 700 | 65 | 700 | 40 | 300 |
| Carbon | | | | | | | |
| Plate | | | | | | | |
| Plate UD1 | 1.3 | 57 | 616 | — | — | — | — |
| (50% wt. | | | | | | | |
| of chips) | | | | | | | |
| Plate UD2 | 1.3 | 85 | 750 | 4 | 40 | 10 | 100 |
| (65% wt. | | | | | | | |
| of chips) | | | | | | | |
| Plate BD1 | 1.3 | 65 | 500 | 15 | 200 | 10 | 100 |
| Plate BD2 | 1.3 | 35 | 400 | 35 | 400 | — | — |

The “UD carbon plate” corresponds to a plate made of a composite material based on new unidirectional carbon fibres.

The “bidirectional carbon plate” corresponds to a plate of a composite material based on new carbon fibres organised in a bidirectional manner, that is to say with an alternation, in equal number, of layers having longitudinal fibres and layers having transverse fibres.

The “Plate UD1” and “Plate UD2” correspond to composite material plates in accordance with embodiments of the invention, obtained as described above, and whose chips, and therefore the fibres, are positioned according to unidirectional arrangement.

The “BD1 Plate” corresponds to a material having a bidirectional arrangement of chips and fibres, namely that the tested plate has two external plies (forming the external surfaces of the part) in which the chips, and therefore the fibres, are positioned in a longitudinal unidirectional arrangement, and an internal ply in which the chips, and therefore the fibres, are positioned in a transverse unidirectional arrangement. The inner ply has a thickness measuring twice the thickness of each outer ply.

The “BD2 Plate” corresponds to a material having a bidirectional arrangement of chips and fibres, namely that the tested plate includes two outer plies in which the chips, and therefore the fibres, are positioned in a longitudinal unidirectional arrangement, and an inner ply in which the chips, and therefore the fibres, are positioned in a transverse unidirectional arrangement. The inner ply has a thickness measuring about six times the thickness of each outer ply (which provides isotropic behaviour in these directions longitudinal and transverse to the panel under reference Plate BD2).

It is notable that the flexural modulus and the tensile strength of the Plate UD2 (with 65% of chips by mass) is significantly greater than 50% of the values obtained for the reference UD Carbon Plate, i.e. a composite material based on comparable new unidirectional fibres (from which the used chips can be extracted). In particular, the flexural modulus obtained, in the longitudinal direction, is equal to 57% of the flexural modulus of the comparable new unidirectional material based on carbon fibres. By bringing these results to equal masses of the panels (taking into account the differences observed in terms of density), the flexural modulus of the Plate UD2 (with 65% of chips by mass) is equal to 63% of the flexural modulus of the reference UD Carbon Plate.

With regard to the panels obtained with a bidirectional organisation, the Plate BD2 offers a similar result. Indeed, in both longitudinal and transverse directions, the flexural modulus and the tensile strength of the Plate BD2 is significantly greater than 50% of the values obtained for the Bidirectional Carbon Plate.

Moreover, the Plate BD1 offers a flexural modulus identical to the reference Bidirectional Carbon Plate in the longitudinal direction (and therefore a performance which is greater to the new panel in this direction, for equal mass), at the cost of lower performance in the transverse direction.

The results presented above demonstrate obtaining recycled materials having high mechanical performance. These results are obtained for materials including a proportion of chips which can be further increased relative to the added amount of adhesive (ratio of 65/35 by mass at most in the represented examples). However, the Applicant has observed that the percentage of chips directly influences the obtained mechanical performance, because it induces the percentage of fibres within the material. In particular, the flexural modulus of the Plate UD2 (containing 65% of chips by mass) is almost 50% higher than that of the Plate UD1 (containing 50% of chips by mass). The breaking strength is increased by more than 20%.

The invention therefore allows obtaining a recycled material which has approximately 70% of the mechanical performance, in particular 70% of the flexural modulus, and (up to 75% to 80% of the performance at identical masses) comparable materials based on new fibres, with a simple manufacturing method, and having a low environmental impact compared to the chemical or thermal recycling methods.

Furthermore, even higher performances can be achieved, the Applicant having successfully produced parts containing more than 65% by mass of chips (in this case up to 78% by mass, and a panel containing about 85% by mass of chip seems feasible).

### EXAMPLE II: CHARACTERIZATION OF THE PANELS OBTAINED ACCORDING TO THE INVENTION

FIG. 6 represents the flexural modulus of a panel in accordance with an embodiment of the invention whose chips are organised in a unidirectional manner, and that of a panel containing new carbon fibres oriented in a unidirectional manner.

The flexural modulus is plotted on the ordinate.

The abscissa shows the angle at which the measurement is carried out. An angle of 0° corresponds to the direction of extension of the fibres or the chips, and 90° corresponds to the direction transverse to the fibres and/or chips.

The triangles correspond to the measurements made on a plate of a material in accordance with an embodiment of the invention whose chips, formed from elements including unidirectional carbon fibres, are organised in a unidirectional manner, whose flexural modulus measured in the direction of extension of the chips and the fibres they contain, is 47 GPa.

The circles represent the theoretical bending moduli calculated for an equivalent plate, formed from a new composite material based on new unidirectional carbon fibres whose flexural modulus in the direction of the fibres it contains would be 47 GPa.

It appears that, surprisingly, the measurements carried out for the composite material formed according to the invention correspond perfectly to the theoretical values obtained for the material formed with new equivalent continuous fibres. Thus, the mechanical properties of an element formed in accordance with the invention, at least for chips including fibres organised in a unidirectional manner and an organisation in plies, are predictable according to the knowledge generally applied to the composite materials based on new equivalent continuous carbon fibres.

### EXAMPLE III: LAMINATED PANELS INCLUDING PLIES MADE WITH A CHIP PATTERN INCLUDING WOVEN CARBON FIBRES

This example related to the formation of a panel using two different non-random patterns of chips, each pattern allowing forming a layer of chips, the layers of chips formed according to the two patterns being arranged alternately in the panel.

For reference, the mechanical properties given in the following table have been determined for a laminated panel having the dimensions: 230 mm×230 mm×4 mm, formed according to a so-called “semi-random” chip arrangement. In such an arrangement, the chips are placed in the mould manually, in order to obtain good filling of the mould, without nevertheless creating a particular or repetitive pattern.

In order to form the reference panel, chips measuring 60 mm×60 mm×0.4 mm were used.

In these examples, the chips are obtained by cutting a composite material incorporating woven carbon fibres, arranged in fabric webs. The cutting to form the chips is carried out as much as possible between the layers.

The adhesive and the conditions for obtaining the panel are similar to those described in EXAMPLE I.

The bending properties (determined by a 3-point bending test, according to standard ISO 14125: 1998) as well as the density of the prototype panels formed in this manner are summarised in table 2 below.

The means and deviations presented in Table 2 below are each obtained on six measurements.

TABLE 2

| | Flexural | Bending tensile | |
|---|---|---|---|
| | modulus | strength | Density |
| Value | (GPa) | (MPa) | (g/cm3) |
| Mean | 29 | 230 | 1.40 |
| CV(%) | 14 | 24 | 5 |

The coefficient of variation CV is the ratio of the standard deviation to the mean, expressed as a percentage. The higher the value of the coefficient of variation, the greater the dispersion around the mean.

The measured bending properties therefore present significant variations between the different produced prototypes. It is noted in particular that the coefficients of variation are much higher than 10% for the mechanical properties.

A laminated panel of the same dimensions (i.e. 230 mm×230 mm×4 mm) was then formed, with chips obtained in the same material as for the reference panel, and of the same thickness.

In order to compose the patterns described with reference to FIGS. 7a, 7b and 7c, chips having the following dimensions were used:
A: 60×60×0.4 mm
B: 60×48×0.4 mm
C: 60×30×0.4 mm
D: 60×18×0.4 mm
E: 48×48×0.4 mm
F: 30×30×0.4 mm
G: 30×18×0.4 mm
H: 18×18×0.4 mm

FIG. 7a represents a first pattern according to which the chips are arranged, edge to edge, to form a layer of 230 mm by 230 mm.

The reference of the used chips (A to H according to the list above) is indicated at each represented chip.

FIG. 7b represents a second pattern according to which the chips are arranged, edge to edge, to form a layer of 230 mm by 230 mm.

The reference of the used chips (A to H according to the list above) is indicated at each represented chip.

In order to form the panel, the chips are placed in the mould, alternating the layers of the first pattern and the layers of the second pattern.

FIG. 7c represents the superimposition of a layer of first pattern (in dotted lines) and a layer of second pattern (in solid line).

The idea behind the formation of this panel is to ensure that an abutment area between two chips, which can constitute an area of mechanical weakness, is always sandwiched between two chips.

It will be noted that the control and the constancy of the thickness of the chips is important because it is this dimension which defines the thickness of each layer (also called ply).

However, the ply thickness is an important parameter in the formation of a laminate (whether it is recycled or not). Having a constant chip thickness therefore allows controlling the thickness of a ply, the arrangement, the thickness of the panel (or the part) formed as well as the mechanical properties thereof.

The prototype panels obtained as described above were also tested according to a 3-point bending test and their density was measured. The obtained values are summarised in the following table 3.

TABLE 3

| | Flexural | Bending tensile | |
|---|---|---|---|
| | modulus | strength | Density |
| Value | (GPa) | (MPa) | (g/cm3) |
| Mean | 29 | 300 | 1.36 |
| CV(%) | 7 | 10 | 1 |

The adoption of a non-random repetitive pattern thus results, with the configuration of the example given here, in an increase in the tensile strength value of approximately 30%.

This means that the areas of weakness in the panel have been diminished.

Moreover, the variation in the mechanical properties between the different panels was greatly reduced, compared to the reference panels. The variation in bending properties has been halved compared to the reference panels, such that the coefficient of variation of the tensile strength is limited to 10%. There is a very little variation in panel density.

Controlling the repetitive pattern (or patterns) and the non-random arrangement of the chips therefore allows obtaining a homogeneous material, whose mechanical properties can be optimised, and are controlled, predictable and little variable.

### EXAMPLE 4: LAMINATED PANELS INCLUDING PLIES MADE WITH A CHIP PATTERN INCLUDING UNIDIRECTIONAL CARBON FIBRES

This example also relates to the formation of a panel using two different non-random patterns of chips, each pattern allowing forming a layer of chips, the layers of chips formed according to the two patterns being arranged alternately in the panel.

For reference, the mechanical properties given in the following table have been determined for a laminated panel with dimensions: 230 mm×230 mm×4 mm, formed according to a so-called “semi-random” chip arrangement. In such an arrangement, the chips are placed in the mould manually, in order to obtain a good filling of the mould, without nevertheless creating a particular or repetitive pattern.

In these examples, the chips are obtained by cutting a composite material incorporating unidirectional carbon fibres.

The used chips have dimensions: 100 mm×10 mm×0.4 mm.

The adhesive and the conditions for obtaining the panel are similar to those described in Example I.

The bending properties (determined by a 3-point bending test, according to standard ISO 14125: 1998) as well as the thickness of the prototype panels thus formed are summarised in table 4 below.

TABLE 4

| | Flexural | Bending tensile | |
|---|---|---|---|
| | modulus | strength | Thickness |
| Value | (GPa) | (MPa) | (mm) |
| Mean | 85 | 886 | 4.83 |
| CV(%) | 8.4 | 10.2 | 6.7 |

Panels (panels 1 and panels 2) were formed, as explained below, with chips having the following dimensions:
I: 100×10×0.4 mm
J: 70×10×0.4 mm
K: 65×10×0.4 mm
L: 55×10×0.4 mm
M: 25×10×0.4 mm

Laminated panels (panels 1) of the same dimensions (i.e. 230 mm×230 mm×0.4 mm) were then formed, with chips obtained in the same material as for the reference panel.

FIG. 8a represents a first pattern according to which the chips are arranged, edge to edge, to form a layer of 230 mm by 230 mm.

FIG. 8b represents a second pattern according to which the chips are arranged, edge to edge, to form a layer of 230 mm by 230 mm.

The panel 1 is formed by alternately superimposing layers of chips according to the pattern of FIG. 8a and according to the pattern of FIG. 8b.

The reference of the used chips (I to N according to the list above) is indicated at each represented chip.

Laminated panels (panels 2) of the same dimensions (i.e. 230 mm×230 mm×4 mm) were then formed, with chips obtained in the same material as for the reference panel.

FIG. 9a represents a first pattern according to which the chips are arranged, edge to edge, to form a layer of 230 mm by 230 mm.

FIG. 9b represents a second pattern according to which the chips are arranged, edge to edge, to form a layer of 230 mm by 230 mm.

The reference of the used chips (I to N according to the list above) is indicated at each represented chip.

The obtained prototype panels (panels 1 and panels 2) as described above were also tested according to a 3-point bending test and their thickness was measured. The obtained values are summarised in the following table 5.

TABLE 5

| | | | Bending | |
|---|---|---|---|---|
| | | Flexural | tensile | |
| | | modulus | strength | Thickness |
| Arrangement | Value | (GPa) | (MPa) | (mm) |
| Panel 1 | Mean | 88 | 826 | 3.00 |
| | CV(%) | 8.8 | 22 | 2.2 |
| Panel 2 | Mean | 107 | 1016 | 2.74 |
| | CV(%) | 8.3 | 10 | 2 |
| (Semi- | Mean | 85 | 886 | 4.83 |
| random) | CV(%) | 8.4 | 10.2 | 6.7 |
| Reference | | | | |
| panel | | | | |

It is noted that the fact of using repetitive patterns and a controlled arrangement of the chips does not necessarily imply results, in terms of mechanical characteristics, that are better than those obtained with a so-called semi-random arrangement (reference panels).

The arrangement 1 allows obtaining panels which have mechanical characteristics equivalent to those of the reference panels, with nevertheless a higher variation with regard to the bending tensile strength.

A much lower rate of variation of the panel thickness is obtained with a non-random device. The fact of using a non-random pattern (or non-random patterns) to make the panel thus allows limiting the thickness dispersions of the produced panels. Indeed, although the panels presented above all have the same number of plies, a “semi-random” arrangement of the chips results in overlapping of certain chips in the same ply. This results in a greater thickness of the panel, and also a greater variation in the thickness from one panel to another.

The panels 2 obtain much better results in bending with similar variations relative to the semi-random arrangement, namely a flexural modulus greater than 25% of the flexural modulus and a tensile strength greater than 15% compared to the reference panel, while the panel 2 is thinner, for the reasons explained above.

Examples III and IV thus show, in general, that the use of a non-random, repetitive pattern can allow improving the mechanical characteristics of the parts formed according to the present invention. This also allows a lower variation in part characteristics. The characteristics obtained being better controlled, stable and predictable, a most accurate sizing of the parts can be made.

1. A composite material part comprising
chips, each chip having a substantially constant thickness defined between two parallel opposite faces of the chip, each chip including carbon fibers which are at least partly included in an adhesive cured during a first curing prior to the formation of said part, at least a majority of said fibers of the chip extending substantially parallel to said opposite faces of the chip, and
a matrix in which each chip is at least partly included, said matrix being formed of a cured adhesive during a second curing,
such that a bonding interface is formed between the matrix and each chip of the part.

2. The composite material part according to claim 1, wherein the bonding interface essentially includes mechanical adhesion bonds.

3. The composite material part according to claim 1, the faces of each chip having a surface area of at least 1 cm².

4. The composite material part according to claim 3, wherein the bonding interface between each chip and the matrix does not have an inflection point, over the entire chip.

5. The composite material part according to claim 1, wherein each chip has a thickness (e) and a largest dimension (d) that can be measured on the surface area of the chip where the ratio (e)/(d) is between 0.05 and 0.0005.

6. The composite material part according to claim 1, wherein the carbon fibers extend mainly in parallel planes.

7. The composite material part according to claim 1, wherein the chips have a unidirectional arrangement of the carbon fibers.

8. The composite material part according to claim 7, wherein the chips are oriented such that the carbon fibers of the part are substantially oriented in the same direction.

9. The composite material part according to claim 1, wherein the chips are oriented so that the carbon fibers of the part are substantially oriented in two distinct directions only.

10. The composite material part according to claim 1, wherein the chips are disposed in a repeating pattern.

11. The composite material part according to claim 1, wherein the chips have substantially the same shape and the same dimensions.

12. The composite material part according to claim 11, wherein the faces of each chip are substantially rectangular in shape.

13. The composite material part according to claim 1, wherein the thickness of the chips is between 200 μm and 1 mm.

14. The composite material part according to claim 1, said part including fibrous areas, formed by the chips and representing between 20% and 85% by volume of the part and non-fibrous areas, consisting of the adhesive which is added and cured during the second curing, forming the remainder of the part.

15. A composite material part comprising:
a plurality of areas including carbon fibers and a first adhesive, the carbon fibers having a non-random orientation within the same area, said areas including carbon fibers having a substantially constant thickness defined between two parallel opposite faces, and all carbon fibers of said areas including carbon fibers being oriented along substantially parallel planes, and
at least one area devoid of carbon fibers, including a second adhesive, the plurality of areas including carbon fibers and a first adhesive being at least partly included in the at least one area devoid of carbon fibers including a second adhesive.

16. The composite material part according to claim 15, wherein the carbon fibers are oriented substantially parallel, orthogonal and/or at 45° within the same area.

17. The composite material part according to claim 15, said part being a flat or curved panel.

18. A method for manufacturing a composite material part, said method including the steps of:
providing a composite material including carbon fibers in an adhesive cured during a first curing;
cutting the composite material into chips, each chip having a substantially constant thickness defined between two parallel opposite faces of the chip, each chip including carbon fibers which are at least partially included in an adhesive cured during a first curing, at least a majority of said fibers of the chip extending substantially parallel to said opposite faces of the chip;
coating the chips with an adhesive;
disposing the chips so as to form an entanglement of chips; and
curing the liquid adhesive, called second curing.

19. The composite material part obtained by the manufacturing method according to claim 18.

20. The composite material part according to claim 9, wherein the chips are oriented in a first direction and a second direction forming an angle of 90° therebetween.
